(19) United States
(12) Patent Application Publication
(10) Pub. No.: US 2009/0271721 A1
(43) Pub. Date: Oct. 29, 2009

(54) ORGANIZATIONAL ROLL-UP/DOWN

(75) Inventors: Jason Andrew Weber, Wauwatosa, WI (US); Gregory J. Shuler, Muskego, WI (US); Joseph T. Bronikowski, New Berlin, WI (US); Todd A. Vance, West Bend, WI (US); Jeffrey Foley, Muskego, WI (US); Russell W. Brandes, Brunswick, OH (US); Adam B. Maki, Claremont, NH (US)

Correspondence Address: TUROCY & WATSON, LLP;ATTENTION: HEATHER HOLMES, 127 Public Square, 57th Floor, Key Tower, Cleveland, OH, 44114, US

(73) Assignee: ROCKWELL AUTOMATION TECHNOLOGIES, INC., Mayfield Heights, OH (US)

(21) Appl. No.: 12/111,690

(22) Filed: Apr. 29, 2008

(51) Int. Cl. G06F 17/30; G06F 3/048

(52) U.S. Cl. 715/764; 707/100; 707/E17.009

(57) ABSTRACT

Information related to an industrial control system can be disclosed graphically on a visual display. To traverse through different system portions, an organizational hierarchy can be used to enable a user to roll down into deeper level or roll up into a higher level. A user can input a choice of a level to view and the level can be disclosed to the user, assuming that the user has appropriate authorization to view the level.

### TECHNICAL FIELD

The subject specification relates generally to industrial control system information presentation and in particular to presenting information through an organizational hierarchy.

### BACKGROUND

Industrial control environments can typically involve complex mechanical, electronic, electromechanical, and/or robotic machinery that perform various automated mechanical and/or electrical functions. Such machinery can include industrial motors, pumps, conveyors, escalators, drills, refrigeration systems, and so on, that can provide a particular physical output. Typically, an industrial environment utilizes one or more control devices to determine when to activate or deactivate such machinery, as well as an appropriate level of activation, (e.g., an amount of current to supply a variable input motor). Additionally, the control devices are associated with logical program code that can determine an appropriate time, degree, manner, etc., to operate such machinery based on various determinable circumstances (e.g., output of another device, reading of an optical sensor, electronic measurement such as current level in a device, movement or number of rotations of a device, and so on).

Different controls can be used to provide protective features in an industrial environment. If a user attempts to make a change upon the industrial environment, then various checks can take place to discover if a user is authorized to make the change, such as requesting the user to enter a username and password. In addition, the user can be provided various tools that can assist in making changes to the industrial environment, including providing a template to be used to make different modifications.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

The disclosed innovation allows for different information levels of an industrial control configuration to integrate together into a seamless organizational hierarchy. Different layers are stacked upon one another and a user can view information on different levels through simple commands, such as engaging an arrow of a keyboard. Functionality can be populated throughout the layers making use of the hierarchy easier for a user, such as a change in one layer populating through other layers. The hierarchy can also be customizable, where rules used in layer presentment are modified and a user can determine how the hierarchy is navigated (e.g., buttons to use for navigation).

An obtainment component can collect a response to a presentation of a first information level, such as a command set with different buttons to view various levels (e.g., a physical level, logical level, etc.) An appropriate level can be chosen by a selection component, oftentimes base upon analysis of the collected response. A transfer component can stack a subsequent information level with the first information level based upon the collected response, where the first information level and subsequent information level are part of an organizational hierarchy.

Use of an organizational hierarchy goes against current market trends and conventional wisdom. Typically, a user has multiple windows that show different levels without integration between the windows. This allows a user to appreciate both levels independently and concurrently, thus little attention has been paid to organizing information into a construct. However, practice of the disclosed innovation allows for appreciation of a relatively large amount of information through using a single construct, which defies market expectations.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative system for implementation of an organizational hierarchy in accordance with an aspect of the subject specification.

FIG. 2 illustrates a representative organizational hierarchy in accordance with an aspect of the subject specification.

FIG. 3 illustrates a representative organizational hierarchy in accordance with an aspect of the subject specification.

FIG. 4 illustrates a representative organizational hierarchy in operation as a command set in accordance with an aspect of the subject specification.

FIG. 5 illustrates a representative system for implementation of an organizational hierarchy with a detailed obtainment component in accordance with an aspect of the subject specification.

FIG. 6 illustrates a representative system for implementation of an organizational hierarchy with a detailed transfer component in accordance with an aspect of the subject specification.

FIG. 7 illustrates a representative methodology for operating a command set in accordance with an aspect of the subject specification.

FIG. 8 illustrates a representative methodology for producing a command set in accordance with an aspect of the subject specification.

FIG. 9 illustrates an example of a schematic block diagram of a computing environment in accordance with an aspect subject specification.

FIG. 10 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

As used herein, the terms to “infer” or “inference” refer generally to the process of reasoning about or deducing states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. In addition, it is to be appreciated that an inference or determination in the subject specification can performed through implementation of artificial intelligence techniques.

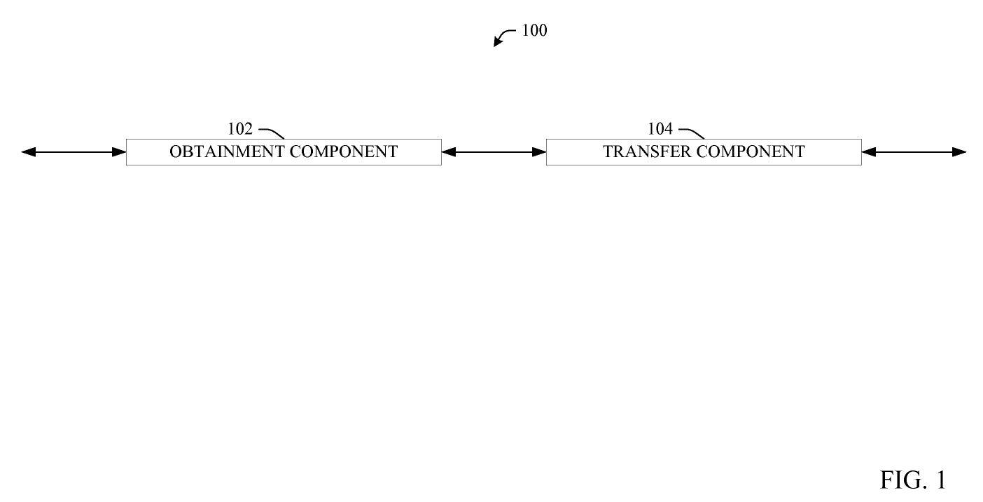

Now referring to FIG. 1, an example system 100 is disclosed for producing a layered, organizational hierarchy that represents operation of an industrial control system. In a conventional industrial control system, a number of devices integrate together to perform a specific task or group of tasks. Commonly these devices are hardware, software, firmware, or a combination thereof. The devices oftentimes arrange in a specific configuration to insure that tasks are performed in a specific order.

However, it can be difficult for an entity (e.g., a user, a controller, and the like) to easily navigate different portions of the industrial control system. The disclosed innovation allows an organizational hierarchy to be presented by an entity that presents information in a navigable form. Through use of the organizational hierarchy, a user can quickly ascertain information that can be of value in understanding system operation, diagnosing system problems, and the like.

Commonly, a layer of information (e.g., a group of information relating to a specific context, such as information of a device, machinery of a device, software of a device, and the like) is presented to a user to allow the user to understand how a control configuration operates. An obtainment component 102 can collect a response to a presentation of a first information level. Example responses can include a user selecting a command associated with the information level or a system response automatically zooming upon a designated area.

In an illustrative instance, a broad level control configuration hardware diagram can be presented to a user as a first information layer. The layer can designate that there is a mechanical error in a specific controller and the user can request to see a mechanical layout of the controller in error. The obtainment component 102 can collect the request through a touch screen, microphone, keyboard, and the like.

An appropriate supplemental level can be chosen and placed above the first information level. A transfer component 104 can stack a subsequent information level with the first information level based upon the collected response, where the first information level and subsequent information level are part of an organizational hierarchy. Stacking of the two levels can include raising the subsequent level above the first level, lowering the first level below the subsequent level, making a level transparent or filled to expose another level, and the like. Commonly, multiple levels link together to form a seamless construct where the levels integrate together. According to one embodiment, a user can flow through different levels by use of conventional means, such as a scroll button on a computer mouse, voice commands, keyboard arrow keys, and the like.

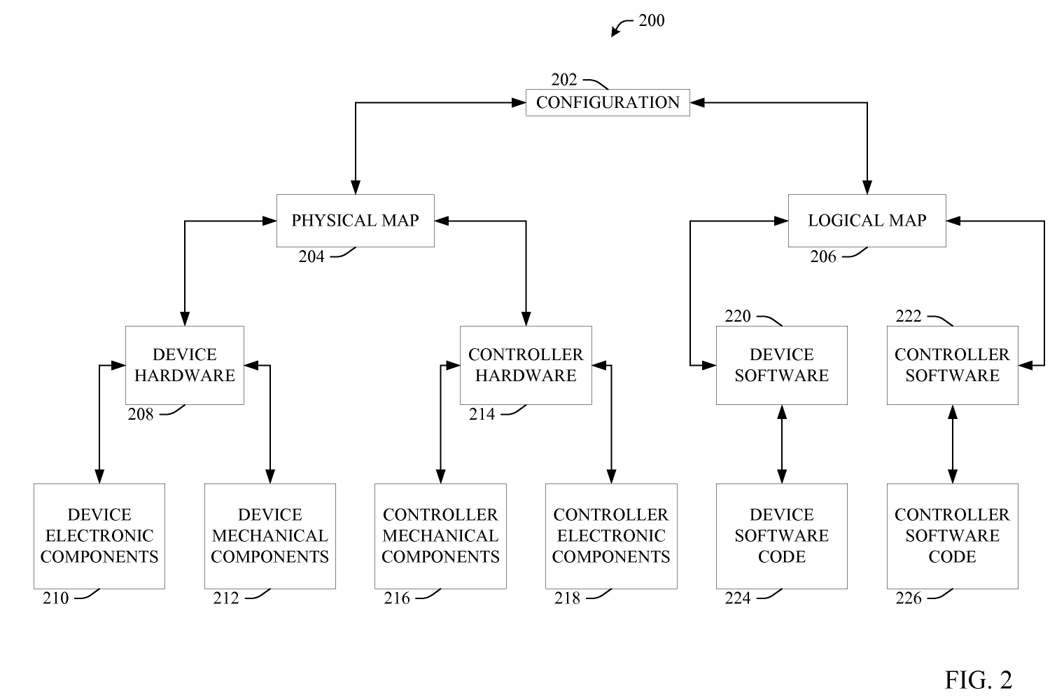

Now referring to FIG. 2, an example organizational hierarchy 200 capable of being traversed by the system 100 of FIG. 1 is disclosed. A user can desire to view how a control system operates at various levels. Initially, a general configuration 202 can be presented to the user (e.g., the configuration 202 represents an industrial control implementation), where limited information is supplied. For example, the configuration 202 can ask a user if she would like to view a physical map 204 or a logical map 206 (as well as other configurations). This can be done by showing representations of physical or logical components, text representations, simple questions, and the like. A user can make a selection and an appropriate level can be stacked with the configuration 202.

In one instance, the user can select to view a physical map 204 of the configuration 202, where different mechanical units can be disclosed as well as metadata concerning the units. In a possible implementation, there can be a device and a controller, each with associated hardware and software. A visual image displayed to the user can show the device flashing, thus indicating there is an error in the device. The user can scroll down to view the device hardware 208 as well as view device electronic components 210 and/or device mechanical components 212. Likewise, controller hardware 214 can be viewed such that controller mechanical components 216 and/or controller electronic components 218 can be viewed, analyzed, diagnosed, and the like. Displayed items, such as the device mechanical components 212, can be presented with metadata, visual or representative images of operation, and so on.

Similar to operation of the physical map 204, the logical map 206 can be presented to the user. The logical map 206 can link a user to device software 220 as well as to controller software 222. As opposed to what is shown in operation of the physical map 204, software of the logical map 206 can associate with a singular level. For instance, device software 220 can have device software code 224 as a lone branch and controller software 222 with controller software code 226 as a single downward relationship. Different information can be shown at different levels; in one illustration, the device software 220 can show functional blocks of code while the device software code 224 shows actual computer instructions.

According to one embodiment, operation of the organizational hierarchy 200 is automated. For instance, an error can take place in device mechanical components 212, such as a motor overheating. A user is initially shown the configuration—after about five second increments, the hierarchy 200 scrolls down through the physical map 204, device hardware 208, and device mechanical component 212. However, it is possible that the hierarchy skip levels such that the device mechanical components 212 directly stack with the configuration 202. The obtainment component 102 of FIG. 1 can collect a response (e.g., user desire to view the physical map 204) to a presentation of a first information level (e.g., configuration 202). A transfer component 104 of FIG. 1 can stack a subsequent information level (e.g., physical map 204) with the first information level (e.g., configuration 202) based upon the collected response. Moreover, a stack performed by the transfer component 104 of FIG. 1 can be linear, meaning two layers stacked along a same tree (e.g., device electronic components 210 can stack with device hardware 208, physical map 204, or configuration 202 directly).

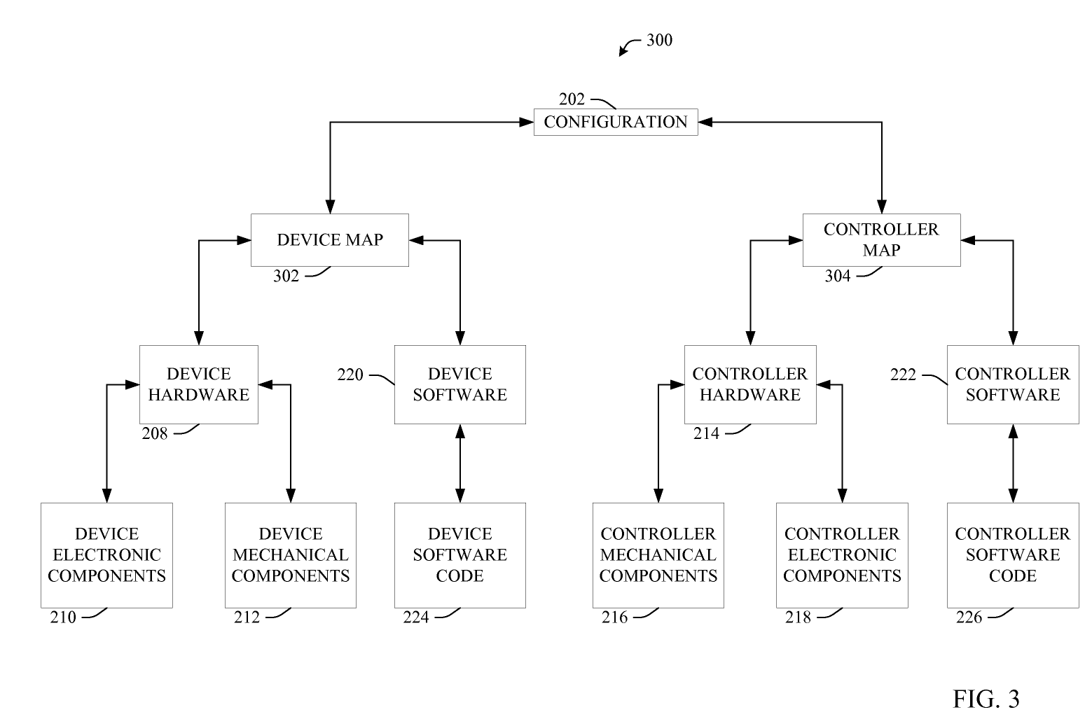

Now referring to FIG. 3, an example organizational hierarchy 300 capable of being traversed by the system 100 of FIG. 1 is disclosed. The organizational hierarchy 300 is similar to the hierarchy 200 of FIG. 2, with several units repeating. However, as opposed a breakdown of a configuration 202 into a physical map 204 of FIG. 2 and logical map 206 of FIG. 2, the breakdown can be between a device map 302 and a controller map 304.

The device map 302 can link with device software 208 that branches into device electronic components 210 and device mechanical components 212. Moreover, the device software 220 can associate with the device map 302 and branch into device software code 224. Likewise, the controller map 304 can associate with controller hardware 214 as well as with controller software 222. The controller hardware 214 can include controller mechanical components 216 as well as controller electronic components 218. The controller software 222 can include a linkage with the controller software code 226.

According to one embodiment, linkages between different representations (e.g., between the device map 302 and the device software 220) do not exist until stacking occurs. In addition, it is possible that the representations themselves do not exist until requested (e.g., entirely do not exist, do not exist in an updated form, and the like). For example, an error can take place in an industrial control implementation and a user can call the configuration 202, which is a broad representation of the implementation. Through viewing information disclosed in the configuration, the user can request to view information concerning a device, where the request is received by the obtainment component 102 of FIG. 1. The device map 302 can be constructed and associated with the configuration 202. The associated device map 302 can be stacked upon the configuration 202, thus allowing the user to appreciated device information.

The user can determine that a problem does not lie with the device and can request that information be viewed concerning a controller. The controller map 304 can be constructed and associated with the configuration 202 and/or with the device map 302—thus, the user can quickly navigate between the different information levels that are not linear. To view information related to different groupings, linear stacking can take place (e.g., device map 302 to configuration 202 and then configuration 202 to controller map 304) as well as direct stacking (e.g., device map 302 to controller map 304).

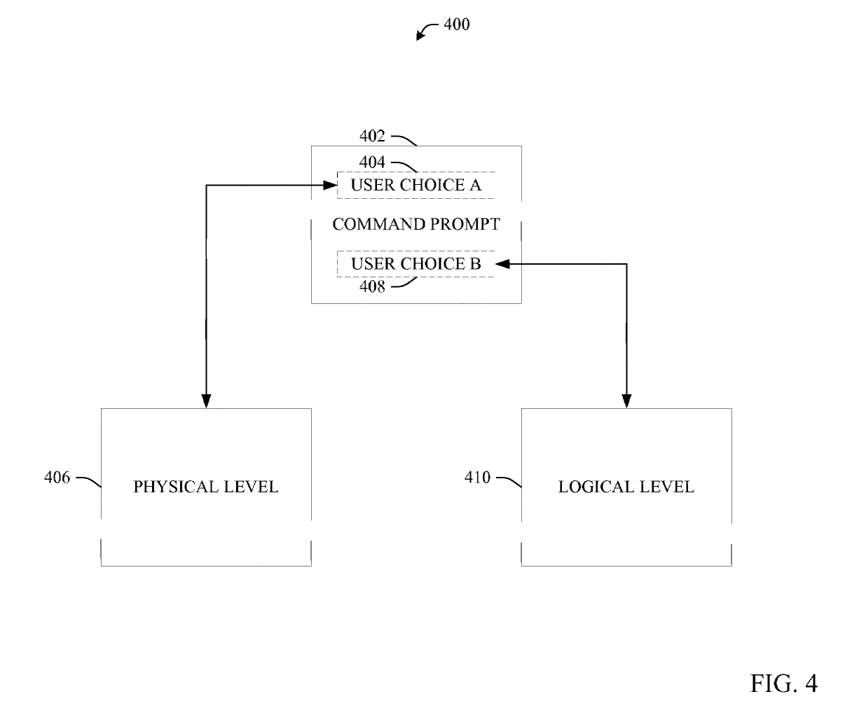

Now referring to FIG. 4, an example command structure 400 is disclosed, where selections of different choices allow for different information levels to be presented to a user. A user can be presented a command prompt 402 with multiple choices, where the command prompt 402 functions as a first information level. Commonly, the command prompt 402 discloses detailed information concerning an industrial control system and several choices available for a user, where selection of a choice produces greater information about a specific area of an industrial control configuration.

In an illustrative instance, the command structure 400 can be used in an industrial control configuration for making soda. Four entities can exist: a liquid supply that provides water, a base supply that provides powder, a mixer that combines the water and powder, and a packager that encloses the combination of water and powder into a single unit (e.g., into twelve ounce cans). An error can take place in the soda making configuration and a user can implement the command structure to discover the error, diagnose the error, solve the error, and the like. In addition, a controller can be used that directs operation of at least one of the four entities.

The command prompt 402 can disclose to the user that an error has taken place along the configuration. Additional information can be disclosed, such as initial diagnostics information, suggested supplemental information for the user to view, and so on. In this example, the entities can have physical elements as well as associated software. User choice A 404 can invite a user to view a physical level 406 of the soda making configuration while user choice B 408 allows the user to view a similar logical level 410.

An obtainment component 102 of FIG. 1 can collect a response of the user, such as a user designating user choice A 404. A transfer component 104 of FIG. 1 can stack the physical level 406 with the command prompt 402, such that physical level 406 is displayed on top of the command prompt 402. After viewing the physical level 406, the user can decide that he has not discovered adequate information (e.g., a cause of the error). The user can return to the command prompt 402 from the physical level 406 and select user choice B 408 that permits the logical level 410 to stack with the command prompt 402. According to an alternative embodiment, the logical level 410 can stack with the physical level 406 without returning to the command prompt 402. It is to be appreciated that aspects disclosed in relation to the command structure 400 can be practiced with the organizational hierarchies 200 and/or 300 as well as other aspects disclosed in the subject specification.

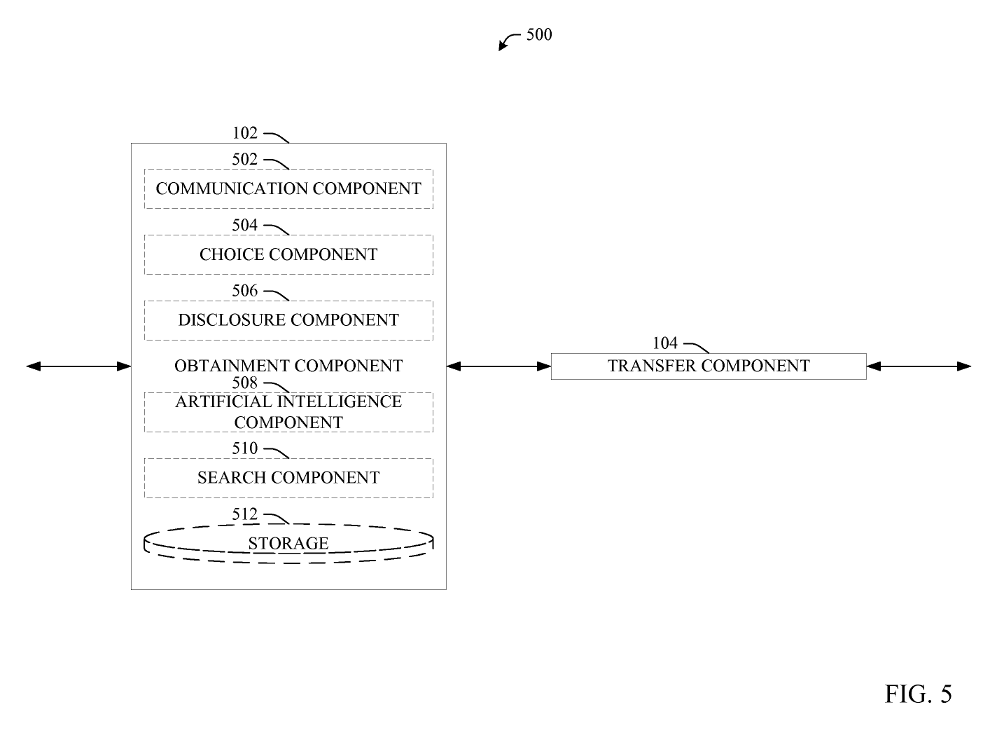

Now referring to FIG. 5, an example system 500 is disclosed for generating an organizational hierarchy with an expanded obtainment component 102. An obtainment component 102 collects a response to a first information level. A communication component 502 can engage with other devices to transfer information. Operation can take place wirelessly, in a hard-wired manner, with employment of security technology (e.g., encryption), etc. Moreover, the communication component 502 can utilize various protective features, such as performing a virus scan on obtained data and blocking information that is positive for a virus.

A choice component 504 chooses a first information level for presentment. Oftentimes, the level chosen for presentment can integrate with a command set allowing a user to view a plurality of levels and information configurations. The command set can include capabilities to stack with new information levels, return to previous information levels, and the like.

A disclosure component 506 presents the command set, first information level, subsequent information level, or a combination thereof to the user. A non-exhaustive list of disclosure components include a display screen, touch screen, speaker system, virtual reality environment, Braille production system, printer, etc. In addition, the disclosure component 506 can present information in multiple formats, such as showing a video with audio capabilities. The disclosure component 506 can operate as a means for presenting a user with a navigable interface, where the user can appreciate provided metadata through the interface in a hierarchical structure.

An artificial intelligence component 508 can make at least one inference or at least one determination in relation to response collection or level stacking. In an example where the disclosure component 506 is a touch screen, the artificial intelligence component 508 can infer when contact of a command set button is accidental or intended to be a choice based upon applied pressure. Moreover, the artificial intelligence component 508 can determine if a user is authorized to make a selection or to view an information level.

The artificial intelligence component 508 can employ one of numerous methodologies for learning from data and then drawing inferences and/or making determinations related to applying a service (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. Methods also include methods for the capture of logical relationships such as theorem provers or more heuristic rule-based expert systems. According to one embodiment, the artificial intelligence component 508 can operate as a means for identifying a problem of an application through implementation of a user-defined rule. The artificial intelligence component 508 can traverse through disparate systems to discover interdependence of components. Additionally, the transfer component 104 can implement as a means for providing metadata that relates to components that are associated with the identified problem.

A search component 510 can locate different entities with which the obtainment component 102 can communicate. For instance, the obtainment component 102 can create information levels and the search component 510 can find data for use in level construction. Moreover, the search component 510 can be used to discover resources to be used in operation of the system 500 (e.g., available storage space).

Different pieces of information, such as obtained information, component operating instructions (e.g., communication component), source location, etc. can be held on storage 512. Storage 512 can arrange in a number of different configurations, including as random access memory, battery-backed memory, hard disk, magnetic tape, etc. Various features can be implemented upon storage 512, such as compression and automatic back up (e.g., use of a Redundant Array of Independent Drives configuration).

The transfer component 104 can stack a first information level with a supplemental information level. While examples of the subject specification disclose a command set as being a first information level, it is to be appreciated that this designation is dynamic and can change based on circumstances. For instance, initially the configuration 202 of FIG. 2 can be the first information level while the physical map 204 of FIG. 2 can be the supplemental information level. Concurrently, the physical map 204 of FIG. 2 can also function as the first information level where the device hardware 208 of FIG. 2 operates as the supplemental information level.

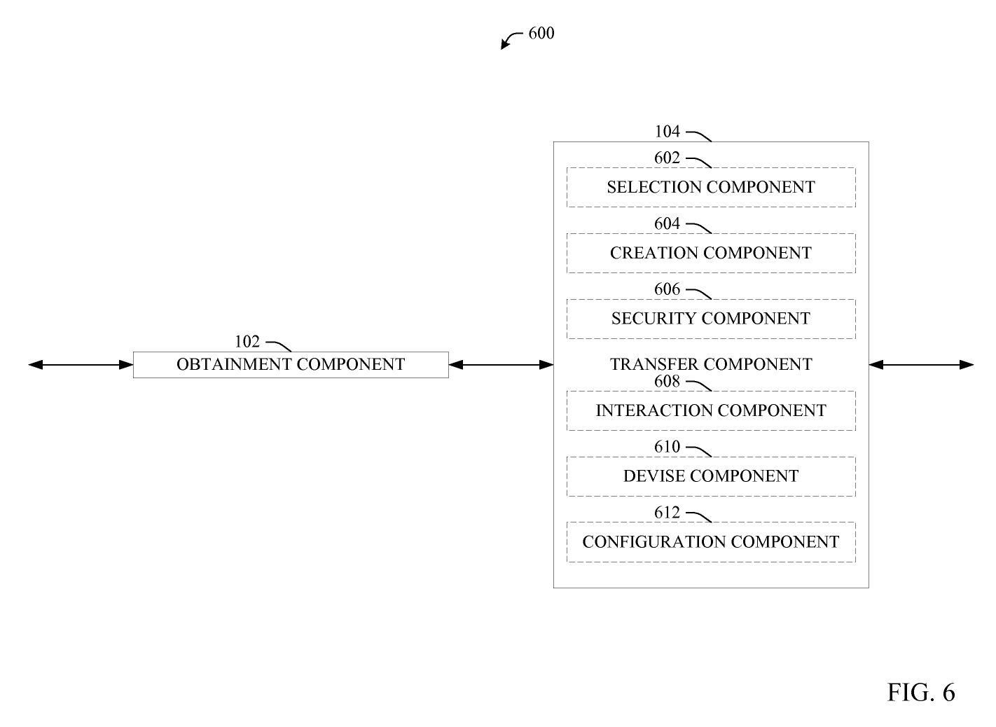

Now referring to FIG. 6, an example system for outputting an organization hierarchy (e.g., an integrated construct with multiple information levels that can be easily traversed) is disclosed with an expanded transfer component 104. An obtainment component 102 can collect a response to a presentation of a first information level. The collected response can be used by the transfer component 104 that stacks a subsequent information level with the first information level based upon the collected response, where the first information level and subsequent information level are part of an organizational hierarchy

A selection component 602 can choose the subsequent information level that the transfer component 104 stacks with the first information level. According to one embodiment, the selection component 602 utilizes at least one rule to choose the subsequent information level that the transfer component 104 stacks with the first information level. The selection component 602 can search for information levels and evaluate levels according to applicability. Moreover, the selection component 602 can function as a means for analyzing discovered interdependencies among components of an industrial control system, identification of the problem is based upon a result of the analysis.

It is possible that an appropriate level does not exist, so therefore a creation component 604 can construct a new information level that can be chosen by the selection component 602. The creation component 604 can use the artificial intelligence component 508 of FIG. 5 to provide diagnostics across an entire application by identifying a problem through user-defined rules and providing associated information and components to the user based on the identified problem. For example, the diagnosed problem can include components involving equipment and procedures. The creation component 604 can traverse through disparate systems to identify interdependencies of connected systems and components to allow the user to navigate through information for diagnostic purposes.

A security component 606 can resolve if an entity is permitted to view the subsequent information level, stack of the subsequent information level and the first information level does not occur unless the entity is permitted. For example, the security component 606 can check authorization of a user by asking a user to provide a password or fingerprint identification. In another example, the security component 606 can restrict access, such as by limiting a number of entities that can view/modify information at a particular level.

An interaction component 608 can enable a user to elect at least one command of a command set, where the first information level includes the command set. According to one embodiment, the first information level includes a command set and the selection component 602 chooses the subsequent information level that the transfer component stacks with the first information level based upon at least one elected command of the command set. The interaction component 608 can integrate with the disclosure component 506 of FIG. 5 as well as be independent, such as a mouse and/or keyboard.

A devise component 610 can facilitate design of an industrial control configuration, the subsequent information level stacked upon the first information level is chosen based upon at least one selection choice of the selection component 602. In an illustrative example, a user can choose for three controllers to operate in a configuration. The system 600, through utilization of the devise component 610, can present a user a level and based on the presented level, other levels are shown (e.g., a configuration can be shown, and for each controller, a hardware and software template can be shown that the is populated by the system 600).

A configuration component 612 can enable a user to create, modify, delete, or a combination thereof at least one rule utilized by the selection component 602. The selection component 602 can use different rules to make a choice, such as assumptions based on a user (e.g., a hardware engineer has a default of being shown a hardware map). A user (e.g., a viewing user, an administrator, and the like) can alter the rule though the interaction component 608, test the rules, and save an altered rule upon the system 500.

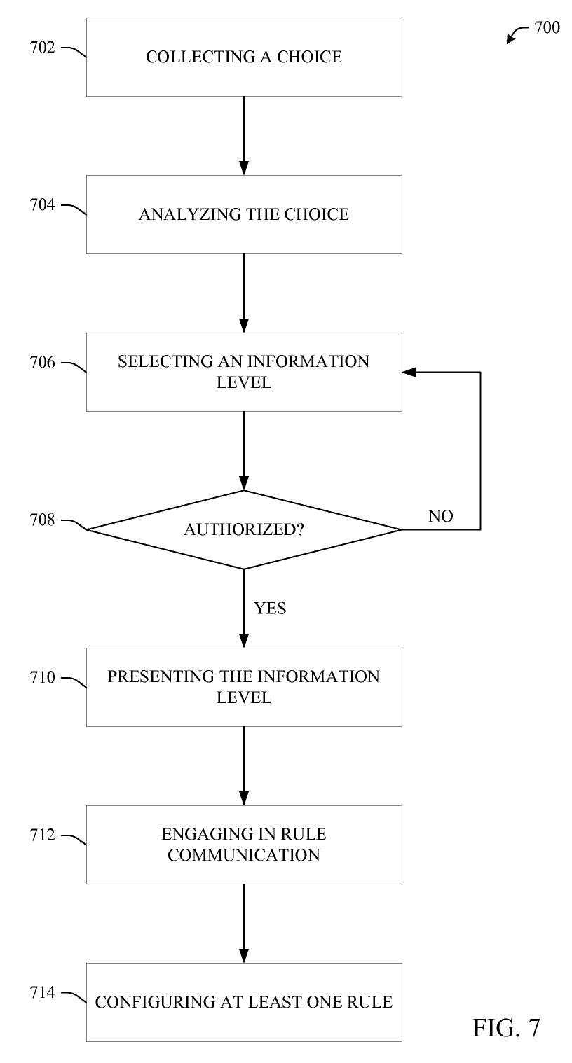

Now referring to FIG. 7, an example methodology 700 is disclosed for stacking information levels in an organizational hierarchy through utilization of a command prompt. At event 702, a choice of a command prompt is collected, commonly through a keyboard, touch screen, mouse input, and the like. Event 702 can represent collecting a choice of a command set where the command set relates to a first information level.

At block 704, the collected choice is analyzed, where a result of the analysis can be used in determining how to proceed with the choice. Analysis can include determining a level that is appropriate for presentment based upon the choice of the user. In addition, analysis can include determining if an error took place with a choice, such as a user requested to view a component that does not exist.

A supplemental information level to be stacked with a disclosed information level, such as a level disclosed to the user to gather the choice, is selected at act 706. Act 706 can include selecting an information level for stacking with the first information level based upon the collected choice. According to one embodiment, act 706 can take a result of the analysis and choose an information level based upon the result.

A check 708 can be made to determine if a requesting party is authorized to view the selected information level. A requesting user can be prohibited from accessing certain information—for example a software programmer on can be prohibited from viewing data on trade secret mechanical parts. The check 708 determines if the user can view a requested level. If the user is not allowed to view an information level, then there can be selection of a different information level, a new choice can be requested, and the like.

The selected information level is presented at event 710, oftentimes based on proper authorization. Commonly, presenting the information level includes stacking an initially presented level with the selected level, such that an entity (e.g., user, controller, and the like) can seamlessly traverse between the levels. While a full information level can be presented, other implementations can be practiced, such as disclosing a user a read-only information level that cannot be changed.

Oftentimes, rules are used to govern how a level is selected, how stacking occurs, etc. A rule communication can be engaged at action 712 that allows for modification of at least one rule. In one example, rule communication can collect a username and password from a user, determine if the user is allowed to change rules, and present a modification application to the user.

At block 714, at least one rule can be configured in a manner that oftentimes alters or enhances operation. A user can modify a rule through one of the information levels as well as through an alternative implementation (e.g., through a computer connected to the configuration). Rule configuration can include changing a rule, deleting a rule, adding a rule, re-instituting a rule, and the like.

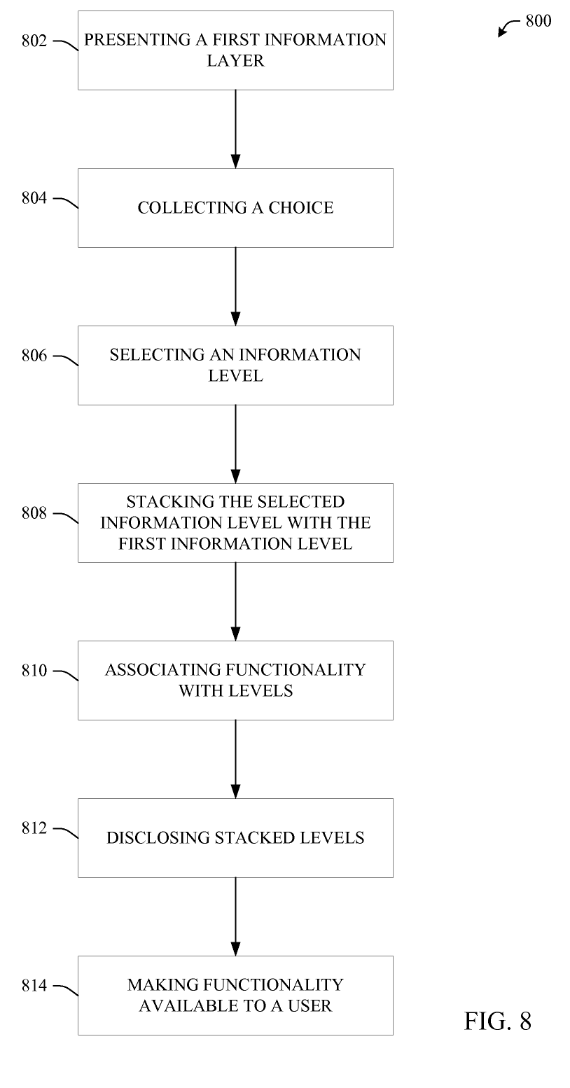

Now referring to FIG. 8, an example methodology 800 is disclosed for divulging an integrated organizational hierarchy. A user can be presented a first information layer at action 802. Commonly, the first information level is a broad representation of an industrial control configuration. With the presentation of the first information level, a user can be given several choices that relate to subsequent levels, such as an opportunity to be presented a physical level or a logical level.

The user can enter a choice for information that should be disclosed in a second information level at event 804. The choice can be facilitated by the presented first information level, such as buttons made available to the user. Commonly, the choices are hard selections, such as a user choosing a physical level or software level. However, it is to be appreciated that the user can design selection choice—for instance, a user can input commands such that in one level some devices are represented mechanically while others have software shown. Event 804 can represent collecting a choice of a command set where the command set relates to a first information level.

Based upon the collected choice at event 804, a subsequent information level can be selected at act 806. Act 806 can operate as selecting an information level for stacking with the first information level based upon the collected choice. A user choice can be analyzed to determine a subsequent information level that is to be stacked. According to one embodiment, act 806 can perform an initial determination to discover if a template level can match (e.g., exactly match, match within a tolerance) a choice of a user. If a template matches, then the matching template is selected; if a template match is not discovered, then a template can be modified or a new level created to match a choice of the user.

At block 808, the first information level and the subsequent information level can be stacked together. Stacking allows for the information level presented in action 802 and the information level selected in act 806 to be integrated together such that there can be seamless movement between the levels. In addition, the levels can link together such that a change in one level can be represented in another level. For instance, if a software level and physical level link together and a change made in the physical level (e.g., movement of a gear) can be automatically represented in the software level (e.g., automatic resolution of associated code).

Stacked information levels can have various amounts of functionality associated upon them at action 810. For instance, functionality can be added that allows a user to make modifications to the industrial control configuration. Moreover, if a configuration portion is in error, stacked levels can represent the error (e.g., a configuration portion in error can flash red).

The stacked levels can be disclosed to the user at action 812, commonly though a display device such as a monitor. According to one embodiment, the subsequent information level is presented over the first information level on one display unit. Moreover, transparency techniques can be used such that while one level is shown, at least one other level can also be viewed (e.g., clear spaces of a top level can allow for portions of a lower level to be seen).

At least some of the functionality associated with the stacked information levels can be made available to the user at event 814. For instance, a physical information level can have buttons activated that allow for greater detail upon certain controllers to be shown when engaged. While event 814 is disclosed as taking place after action 812, it is to be appreciated that it event 814 can occur at other times, such as concurrent with action 812.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

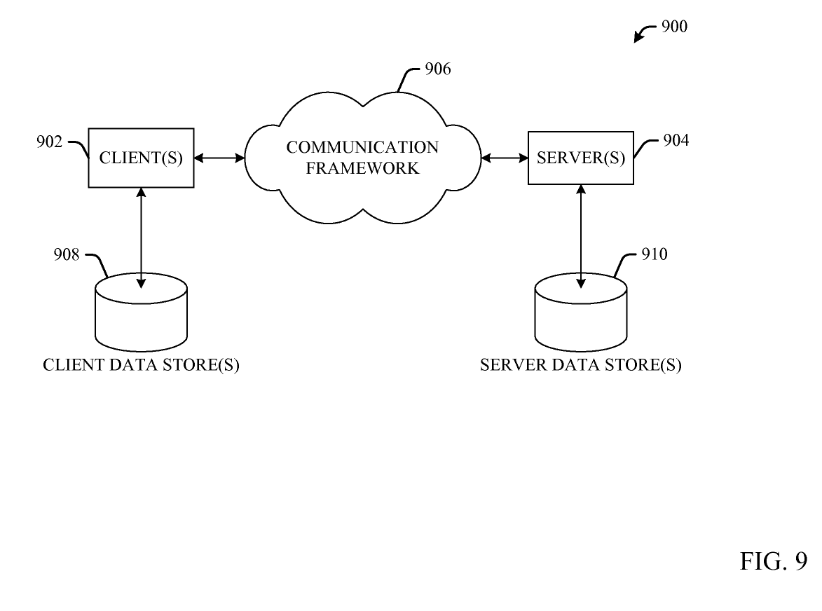

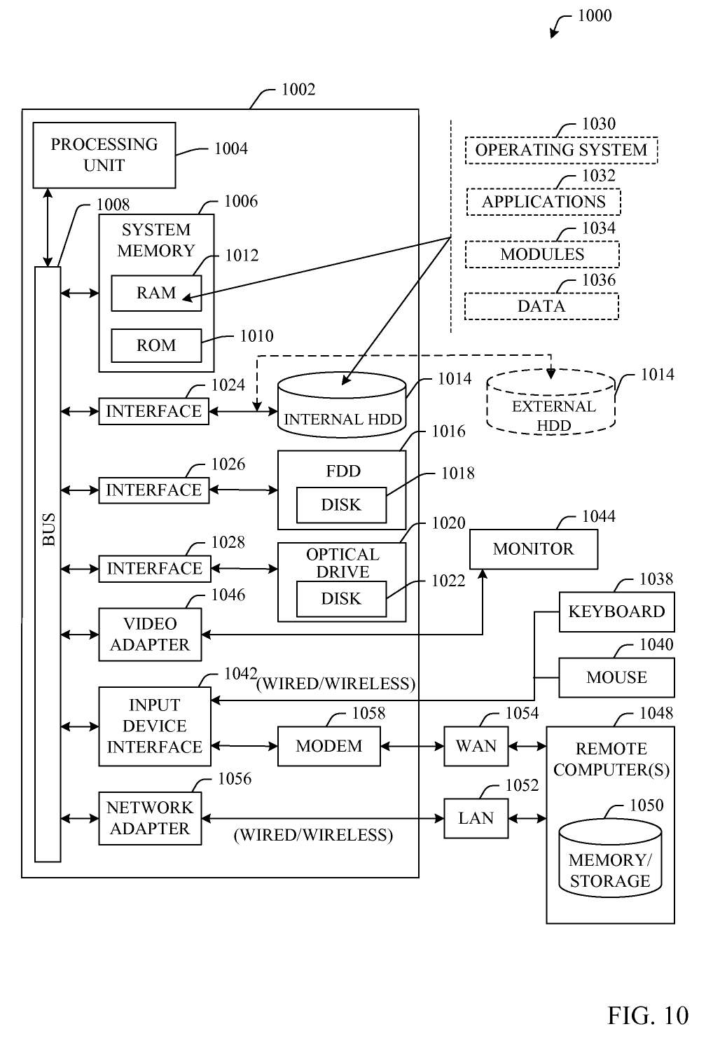

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embody computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors or proprietary specific configured processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various proprietary or commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the input device interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The aforementioned systems have been described with respect to interaction among several components. It should be appreciated that such systems and components can include those components or sub-components specified therein, some of the specified components or sub-components, and/or additional components. Sub-components can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system capable of implementation upon an industrial control configuration, comprising:
an obtainment component that collects a response to a presentation of a first information level; and
a transfer component that stacks a subsequent information level with the first information level based upon the collected response, where the first information level and subsequent information level are part of an organizational hierarchy.

2. The system of claim 1, further comprising a selection component that chooses the subsequent information level that the transfer component stacks with the first information level.

3. The system of claim 2, the selection component utilizes at least one rule to choose the subsequent information level that the transfer component stacks with the first information level.

4. The system of claim 3, further comprising a configuration component that enables a user to create, modify, delete, or a combination thereof at least one rule utilized by the selection component.

5. The system of claim 2, the first information level includes a command set and the selection component chooses the subsequent information level that the transfer component stacks with the first information level based upon at least one elected command of the command set.

6. The system of claim 5, further comprising an interaction component that enables a user to elect at least one command of the command set.

7. The system of claim 6, further comprising a disclosure component that presents the command set, first information level, subsequent information level, or a combination thereof to the user.

8. The system of claim 2, further comprising a devise component that facilitates design of an industrial control system, the subsequent information level stacked upon the first information level is chosen based upon at least one selection choice of the selection component.

9. The system of claim 1, further comprising an artificial intelligence component that makes at least one inference or at least one determination in relation to response collection or level stack.

10. The system of claim 1, the stack performed by the transfer component is linear.

11. The system of claim 1, further comprising a security component that resolves if an entity is permitted to view the subsequent information level, stack of the subsequent information level and the first information level does not occur unless the entity is permitted.

12. An industrial control method, comprising:
collecting a choice of a command set where the command set relates to a first information level; and
selecting an information level for stacking with the first information level based upon the collected choice.

13. The method of claim 12, further comprising presenting the selected information level as stacked with the first information level.

14. The method of claim 12, the selected information level includes another command set.

15. The method of claim 12, further comprising analyzing the choice of the command set, a result of the analysis is used in selecting an information level for presentation

16. The method of claim 12, further comprising configuring at least one rule used in selecting the information level.

17. A system capable of implementation upon an industrial control configuration, comprising:
means for identifying a problem of an application through implementation of a user-defined rule; and
means for providing metadata that relates to components that are associated with the identified problem.

18. The system of claim 17, further comprising means for analyzing discovered interdependencies among components of an industrial control system, identification of the problem is based upon a result of the analysis.

19. The system of claim 18, the means for identifying a problem traverses through disparate systems to discover interdependence of components.

20. The system of claim 17, further comprising means for presenting the user with a navigable interface, where the user can appreciate the provided metadata through the interface in a hierarchical structure.
